(19) United States
(12) Patent Application Publication
(10) Pub. No.: US 2010/0252651 A1
(43) Pub. Date: Oct. 7, 2010

(54) FUEL INJECTION APPARATUS

(75) Inventors: Shu Kagami, Nagoya-city (JP); Jun Kondo, Nagoya-city (JP); Tomoki Fujino, Okazaki-city (JP); Yutaka Miyamoto, Takahama-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/752,521

(22) Filed: Apr. 1, 2010

(30) Foreign Application Priority Data
Apr. 3, 2009 (JP) 2009-90704

(51) Int. Cl. F02M 61/16; F02M 61/00

(52) U.S. Cl. 239/106; 239/533.12

(57) ABSTRACT

A fuel injection apparatus that includes a body, a nozzle, a pressure control unit, and a physical quantity measurement unit. The body has a fuel inlet port and a high-pressure fuel passage that is communicated with the fuel inlet port. The pressure control unit controls opening and closing of the nozzle. The fuel inlet port projects in a radially outward direction of the body. The body includes a fuel outlet port located on a lateral side of a longitudinal axis of the body opposite from the fuel inlet port. The physical quantity measurement unit is provided between the fuel inlet port and the fuel outlet port, and the physical quantity measurement unit measures a physical quantity of high pressure fuel introduced from the fuel inlet port.

### CROSS REFERENCE TO RELATED APPLICATION

This application is based on and incorporates herein by reference Japanese Patent Application No. 2009-90704 filed on Apr. 3, 2009.

### BACKGROUND OF THE INVENTION

1. Field of the Invention

The present invention relates to a fuel injection apparatus that injects fuel to an internal combustion engine.

2. Description of Related Art

In a conventional fuel injection system, a rail pressure is detected by a pressure sensor, and the detected pressure of high pressure fuel is sent to an engine ECU. More specifically, the pressure sensor is provided at a common rail that supplies high pressure fuel to a fuel injection apparatus, or the pressure sensor is provided between the common rail and the fuel injection apparatus. Also, the rail pressure indicates pressure of high pressure fuel that is supplied to the fuel injection apparatus.

Also, the fuel injection apparatus has a pressure control unit that controls opening and closing of a nozzle by controlling pressure applied to a nozzle needle of the needle in accordance with electric signals received from an engine ECU. Thus, the pressure control unit executes an injection control of fuel (see, for example, JP-A-2008-240544).

However, in the above fuel injection system, the engine ECU is required to be wired to a pressure sensor that detects the pressure of high pressure fuel introduced to the fuel injection apparatus. Furthermore, the engine ECU is also required to be wired to the pressure control unit that controls the opening and closing of the nozzle by controlling the pressure applied to the nozzle needle. Thus, the operability in the assembly of the fuel injection apparatus to the vehicle may deteriorate disadvantageously.

Thus, a physical quantity measurement unit for detecting a physical quantity of high pressure fuel, such as pressure sensor, may be mounted on the fuel injection apparatus, and the physical quantity measurement unit is used for detecting the physical quantity of high pressure fuel introduced to the fuel injection apparatus. However, in the above case, where the physical quantity measurement unit is newly mounted to the fuel injection apparatus that originally does not have the measurement unit, the size of the fuel injection apparatus may increase disadvantageously.

### SUMMARY OF THE INVENTION

The present invention is made in view of the above disadvantages. Thus, it is an objective of the present invention to address at least one of the above disadvantages.

To achieve the objective of the present invention, there is provided a fuel injection apparatus that includes a body, a nozzle, a pressure control unit, and a physical quantity measurement unit. The body has a fuel inlet port and a high-pressure fuel passage. High pressure fuel is introduced through the fuel inlet port. The high-pressure fuel passage is communicated with the fuel inlet port. The nozzle has an injection orifice that allows high pressure fuel to be injected therethrough when the nozzle is opened, and high pressure fuel is introduced to the nozzle from the fuel inlet port through the high-pressure fuel passage. The pressure control unit controls opening and closing of the nozzle by controlling pressure applied to a nozzle needle of the nozzle in accordance with an electric signal received from an exterior. The fuel inlet port projects in a radially outward direction of the body. The body includes a fuel outlet port located on a lateral side of a longitudinal axis of the body opposite from the fuel inlet port, and the fuel outlet port allows excessive fuel within the fuel injection apparatus to be drained. The physical quantity measurement unit is provided between the fuel inlet port and the fuel outlet port, and the physical quantity measurement unit measures a physical quantity of high pressure fuel introduced from the fuel inlet port.

### BRIEF DESCRIPTION OF THE DRAWINGS

The invention, together with additional objectives, features and advantages thereof, will be best understood from the following description, the appended claims and the accompanying drawings in which:

FIG. 1 is a cross-sectional view illustrating a fuel injection apparatus according to one embodiment of the present invention;

FIG. 2 is an enlarged cross-sectional view of a part II in FIG. 1; and

FIG. 3 is a block diagram illustrating an injection control of the fuel injection apparatus.

### DETAILED DESCRIPTION OF PREFERRED EMBODIMENTS

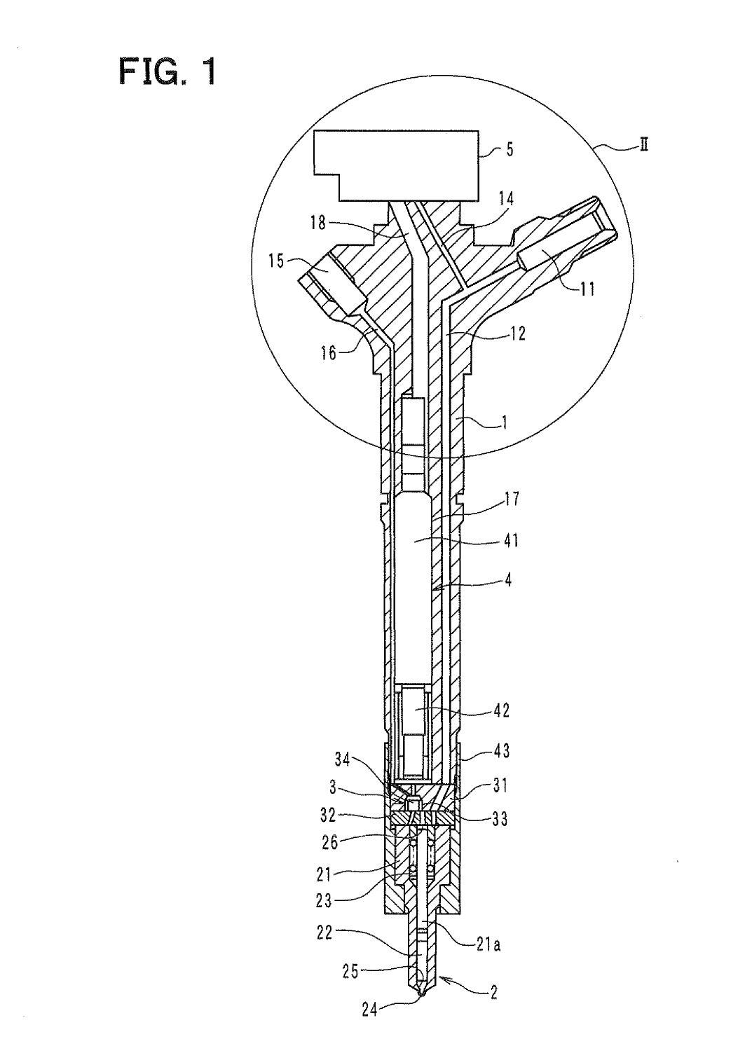

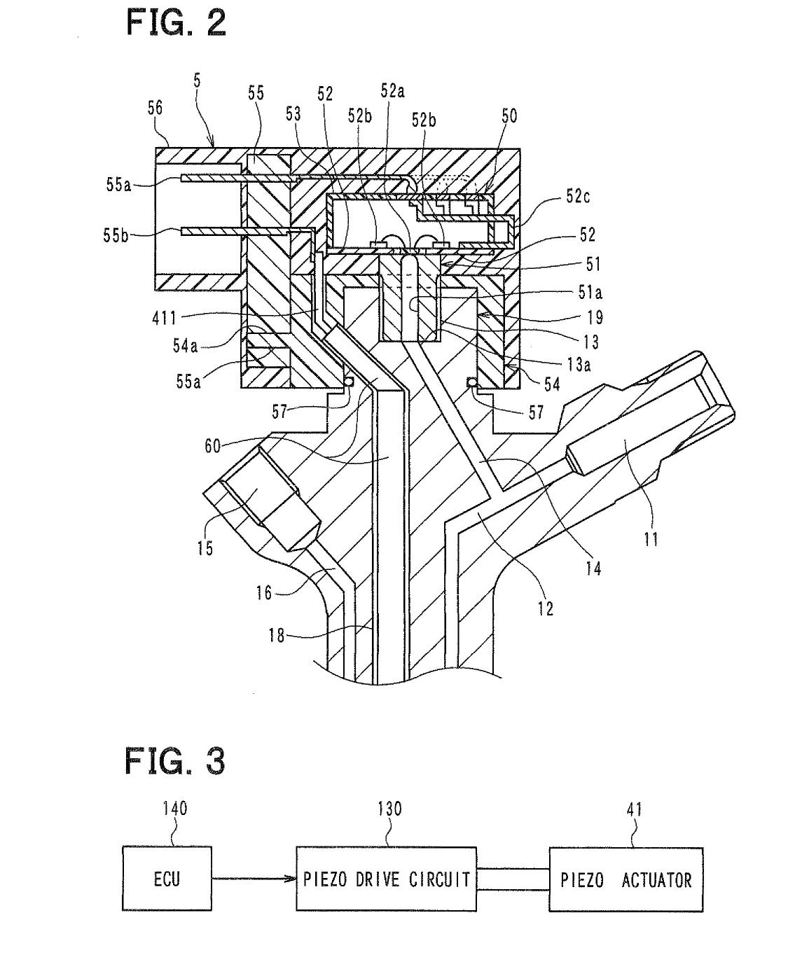

FIG. 1 shows a schematic cross-sectional view illustrating a general configuration of a fuel injection apparatus according to one embodiment of the present invention. Also, FIG. 2 is an enlarged diagram schematically illustrating a part II in FIG. 1. For example, scales in FIG. 2 of some parts may be different from the corresponding scales in FIG. 1. The fuel injection apparatus of the present embodiment is mounted on a cylinder head of an internal combustion engine (not shown), or more specifically, of a diesel engine. Also, the fuel injection apparatus injects high pressure fuel accumulated in a common rail (not shown) into a cylinder of the internal combustion engine.

As shown in FIG. 1, the fuel injection apparatus has a body 1 that is formed by forging and machining a metal material, such as ferrous alloy. The body 1 has a fuel inlet port 11, a high-pressure fuel passage 12, a mount hole 13, a high pressure fuel branch passage 14, a fuel outlet port 15, a low pressure fuel passage 16, a receiving bore 17, and a lead wire hole 18. The fuel inlet port 11 is a passage that receives high pressure fuel from the common rail. The high-pressure fuel passage 12 leads the high pressure fuel, which is introduced through the fuel inlet port 11, to a nozzle 2 (described later) that is positioned on one longitudinal end (first longitudinal end) of the body 1 (lower end of the body 1 in FIG. 1). The mount hole 13 is formed at the other longitudinal end (second longitudinal end) of the body 1 (upper end of the body 1 in FIG. 1, see FIG. 2) opposite from the nozzle 2. The high pressure fuel branch passage 14 branches from the high-pressure fuel passage 12 to extends toward the mount hole 13. The fuel outlet port 15 is a passage that allows fuel to be drained to a fuel tank (not shown). The low pressure fuel passage 16 leads excess fuel in the fuel injection apparatus to the fuel outlet port 15. The receiving bore 17 has a cylindrical shape and receives therein an actuator 4 (described later). The lead wire hole 18 has a cylindrical shape and allows lead wires 411 of the actuator 4 to extend therethrough to the exterior (see FIG. 2). It should be noted that the fuel inlet port 11 is formed to project toward the body 1, and the body 1 has the fuel outlet port 15 that is positioned on a lateral side of a longitudinal axis of the body 1 opposite from the fuel inlet port 11. As above, the body 1 has a Y-shape having the fuel inlet port 11 and the fuel outlet port 15 that are generally symmetrically provided relative to the axis of the body 1. For example, the fuel inlet port 11 projects or extends from the longitudinal part of the body 1 in a first radially outward direction of the body 1 (rightward in FIG. 1). Also, the fuel outlet port 15 projects or extends from the longitudinal part of the body 1 in a second radially outward direction of the body 1 (leftward in FIG. 1), which second direction is generally opposite from the first radially outward direction.

The nozzle 2 is provided at the one longitudinal end of the body 1, and injects fuel when the nozzle 2 is opened. The nozzle 2 has a nozzle body 21, a nozzle needle 22, and a nozzle spring 23. The nozzle body 21 has a generally hollow cylindrical shape, and the nozzle body 21 slidably supports therein the nozzle needle 22. The nozzle spring 23 urges the nozzle needle 22 in a valve closing direction for closing the nozzle 2.

The nozzle body 21 has an injection orifice 24 at one longitudinal end, and the injection orifice 24 is communicated with the fuel inlet port 11 through the high-pressure fuel passage 12. High pressure fuel is injected into a cylinder of the internal combustion engine through the injection orifice 24. A tapered valve seat 25 is formed upstream of the injection orifice 24 in the fuel flow direction, and the nozzle needle 22 has a seat portion formed at an end thereof. The seat portion of the nozzle needle 22 is engaged with and disengaged from the valve seat 25 to close and open the injection orifice 24.

The other end portion of the nozzle needle 22 opposite from the injection orifice 24 defines a control chamber 26, fuel pressure in which is changeable between high pressure and low pressure. The nozzle needle 22 is urged in the valve closing direction for closing the nozzle 2 by fuel pressure in the control chamber 26. In contrast, the nozzle needle 22 is urged in a valve opening direction for opening the nozzle 2 by high pressure fuel that is introduced to the injection orifice 24 from the fuel inlet port 11 through the high-pressure fuel passage 12.

A control valve 3 is provided between the body 1 and the nozzle 2, and controls pressure in the control chamber 26. The control valve 3 includes a first plate 31, a second plate 32, and a valve element 34. The first and second plates 31, 32 define therebetween a valve chamber 33, and the valve chamber 33 receives therein the valve element 34. It should be noted that the body 1, the nozzle 2, the first plate 31, and the second plate 32 are connected through a retaining nut 43.

The valve chamber 33 is always communicated with the control chamber 26. Also, it is possible to provide communication between the valve chamber 33 and the low pressure fuel passage 16 and between the valve chamber 33 and the high-pressure fuel passage 12. Specifically, the valve element 34 opens and closes (enables and disables) the communication between the valve chamber 33 and the low pressure fuel passage 16 and the communication between the valve chamber 33 and the high-pressure fuel passage 12.

The actuator 4 actuates the valve element 34 in order to control pressure in the control chamber 26 such that the nozzle 2 is controlled (or is opened and closed). The actuator 4 includes a cylindrical piezo actuator 41 and a transmitter 42. The piezo actuator 41 has multiple piezo elements stacked upon one another, and expands and contracts by electrically charging and discharging the piezo actuator 41. The transmitter 42 transmits the displacement of the piezo actuator 41, which is caused by the expansion and contract of the piezo actuator 41, to the valve element 34. It should be noted that the control valve 3 and the actuator 4 constitute a pressure control unit.

As shown in FIG. 2, the piezo actuator 41 is provided with electric power through a piezoelectric drive circuit 130. The piezoelectric drive circuit 130 is configured to control voltage applied to the piezo actuator 41 in order to change an expansion amount of the piezo actuator 41. An electronic control circuit 140 (hereinafter, referred as ECU) controls the voltage applied to the piezo actuator 41 by the piezoelectric drive circuit 130 and controls timing of energizing the piezo actuator 41 by the piezoelectric drive circuit 130.

The ECU 140 includes a known microcomputer having a CPU, a ROM, an EEPROM, and a RAM (all of which are not shown), and the CPU executes calculation processes based on programs stored in the ROM. Also, the ECU 140 receives signals from various sensors (not shown) that detect, for example, an intake air amount, a depressing amount of an accelerator pedal, a rotational speed of the engine, and fuel pressure in the common rail.

Next, the operation of the fuel injection apparatus will be described. Firstly, when the piezo actuator 41 is electrically charged, the piezo actuator 41 expands, and thereby the piezo actuator 41 actuates, through the transmitter 42, the valve element 34 toward the injection orifice 24 (or in the downward direction in FIG. 1). Accordingly, when the valve element 34 is actuated as above; the communication between the valve chamber 33 and the low pressure fuel passage 16 is enabled, and also the communication between the valve chamber 33 and the high-pressure fuel passage 12 is disabled.

As a result, the control chamber 26 is communicated with the low pressure fuel passage 16 through the valve chamber 33, and thereby pressure in the control chamber 26 decreases. Accordingly, the force that urges the nozzle needle 22 in the valve closing direction decreases, and thereby the nozzle needle 22 moves in the valve opening direction. Then, the seat portion of the nozzle needle 22 is disengaged from the valve seat 25, and thereby the injection orifice 24 is opened. In this way, fuel is injected to the cylinder of the internal combustion engine through the injection orifice 24.

When the piezo actuator 41 is electrically discharged later, the piezo actuator 41 contracts, and thereby the valve element 34 is actuated by a spring (not shown) in a direction away from the injection orifice 24 (upward direction in FIG. 1). Then, due to the actuation of the valve element 34, the communication between the valve chamber 33 and the low pressure fuel passage 16 is disabled, and the communication between the valve chamber 33 and the high-pressure fuel passage 12 is enabled.

As a result, the control chamber 26 is communicated with the high-pressure fuel passage 12 through the valve chamber 33, and thereby pressure in the control chamber 26 increases. Accordingly, force that urges the nozzle needle 22 in the valve closing direction increases, and thereby the nozzle needle 22 moves in the valve closing direction. Thus, the seat portion of the nozzle needle 22 contacts the valve seat 25, and thereby the injection orifice 24 is closed to end the fuel injection.

The fuel injection apparatus of the present embodiment has a connector portion 5 that is positioned at the other longitudinal end of the body 1 remote from the nozzle 2. The connector portion 5 includes therein a pressure sensor that detects pressure of high pressure fuel introduced from the common rail.

As shown in FIG. 2, the connector portion 5 includes a pressure sensor 50, a cover member 54, and a positioning member 55 that are integrally molded by a resin material. In other words, the pressure sensor 50, the cover member 54, and the positioning member 55 are insert molded to form the connector portion 5. It should be noted that a connector housing portion 56 is a part of the connector portion 5.

The pressure sensor 50 is provided between the fuel inlet port 11 and the fuel outlet port 15 and is located on the other longitudinal end of the body 1 remote from the injection orifice 24.

The pressure sensor 50 includes a metal threaded member 51, circuit board 52, and a metal sensor cover 53. The circuit board 52 has thereon circuit components, such as a pressure detecting element 52a, a circuit chip 52b, a terminal 52c. The metal sensor cover 53 is provided to protect the circuit board 52. It should be noted that the circuit board 52 has a flat shape, and the circuit board 52 and the pressure detecting element 52a are attached to an upper surface of the threaded member 51.

The threaded member 51 is threadably engaged with the mount hole 13 of the body 1 such that the pressure sensor 50 is fixed to the body 1. More specifically, the mount hole 13 is a threaded hole, which has an internal threaded part, and which is located on the other longitudinal end of the body 1.

The threaded member 51 is formed with an external threaded part at an outer peripheral surface of the threaded member 51. Also, the threaded member 51 has a bore 51a therein to have a tubular shape. The bore 51a extends from (a) an end (lower end in FIG. 2) of the threaded member 51 formed adjacent a bottom surface 13a of the mount hole 13 to (b) the pressure detecting element 52a formed on the upper surface of the threaded member 51. In other words, the bore 51a opens at the upper surface (upper end in FIG. 2) of the threaded member 51, and the pressure detecting element 52a is attached to the upper surface of the threaded member 51 correspondingly to the opening of the bore 51a at the upper surface.

Also, the high pressure fuel branch passage 14 branches from the high-pressure fuel passage 12 and extends toward the bottom surface 13a of the mount hole 13.

Thus, high pressure fuel introduced through the fuel inlet port 11 reaches the pressure detecting element 52a via the high-pressure fuel passage 12, the high pressure fuel branch passage 14, and the bore 51a of the threaded member 51.

The circuit board 52 is mounted with circuit components, such as the pressure detecting element 52a, the circuit chip 52b. Typically, the circuit components are wired through bonding wires.

Multiple electrodes are provided at an upper surface of the sensor cover 53, and the electrodes are connected to the circuit components through the multiple terminals 52c. For example, the circuit components are mounted on the circuit board 52, and include the pressure detecting element 52a and the circuit chip 52b.

The body 1 has a projection portion 19 that projects in the axial direction of the body 1 away from the injection orifice 24. There is formed a groove at an outer periphery of the projection portion 19, and the groove is fitted with an O-ring 57 that provides air-tightness.

The cover member 54 includes a threaded hole, a lead wire hole, and a projection portion 54a. The threaded hole receives therein the threaded member 51 of the pressure sensor 50 that extends through the threaded hole. The lead wire hole receives therein the two lead wires 411 that is connected with the piezo actuator 41 for supplying electric power thereto. The projection portion 54a functions to locate the positioning member 55 at a position.

The cover member 54 is attached to the hollow cylindrical projection portion 19 of the body 1 such that the cover member 54 covers the O-ring 57. The O-ring 57 limits fuel, oil, water from entering into the pressure sensor 50 and the lead wire hole 18 through a clearance formed between the projection portion 19 of the body 1 and the cover member 54.

The cover member 54 has a lead wire hole, which receives therein a resin bush guide 60. The bush guide 60 is formed with two holes for guiding the two lead wires 411 of the piezo actuator 41. The two lead wires 411 of the piezo actuator 41 are separately inserted into the respective two holes of the bush guide 60, and have end parts that project from the end surface of the cover member 54. It should be noted that the two lead wires 411 of the piezo actuator 41 are provided with electrically insulation covers except for the end portions.

The positioning member 55 fixes terminals 55a, 55b at predetermined positions. The positioning member 55 includes multiple holes, the terminals 55a, 55b, and a fit hole 55c. The terminals 55a, 55b are received by the multiple holes of the positioning member 55, and the fit hole 55c is fitted with the projection portion 54a of the cover member 54.

By fitting the projection portion 54a provided to the cover member 54 into the fit hole 55c of the positioning member 55, the terminals 55a, 55b are fixed at the predetermined positions.

There are four terminals 55a although FIG. 2 shows only three terminals 55a. The four terminals 55a (first terminals) are connected by welding with respective electrodes provided at the upper surface of the sensor cover 53.

There are two terminals 55b although FIG. 2 shows only one terminal 55b, and the two terminals 55b (second terminals) are connected by welding with the two lead wires 411 of the piezo actuator 41.

the connector housing portion 56 is a part of a mold body, which is integrally made of a resin material by insert molding of the pressure sensor 50, the cover member 54, and the positioning member 55. The connector housing portion 56 functions as a connector, and the terminals 55a, 55b of the positioning member 55 functions as connector terminals of the connector.

The connector housing portion 56 is connected with the ECU 140 through a single connector cable (not shown).

Next, the assembly of the pressure sensor 50, the cover member 54, and the positioning member 55 to the body 1 will be described with reference to FIG. 2.

Firstly, the O-ring 57 is attached to an outer peripheral part of the projection portion 19 of the body 1, and the cover member 54 is press fitted with the projection portion 19 of the body 1 such that the cover member 54 covers the O-ring 57.

Next, the bush guide 60, which receives therein the two lead wires 411 of the piezo actuator 41, is inserted into the lead wire hole 18 of the body 1 from the one longitudinal end of the body 1. Then, the two lead wires 411 of the piezo actuator 41 are pulled out of the lead wire hole of the cover member 54.

Next, the pressure sensor 50 is threadably engaged with the projection portion 19 of the body 1. Specifically, the threaded member 51 of the pressure sensor 50 is threadably engaged with the mount hole 13 formed at the projection portion 19 of the body 1 such that the pressure sensor 50 is threadably engaged with the projection portion 19 of the body 1.

Next, the fit hole 55c of the positioning member 55 is fitted with the projection portion 54a provided to the cover member 54. Then, in the above state, each electrode provided on the upper surface of the sensor cover 53 is welded to the respective terminal 55a, and also, the two lead wires 411 of the piezo actuator 41 are welded to the terminals 55b.

Next, the connector portion 5 is integrally made of the resin material through the insert molding of the pressure sensor 50, the cover member 54, and the positioning member 55. It should be noted that mold temperature ranges from 280 through 300° C. Also, the O-ring 57 is covered by the cover member 54 such that the O-ring 57 is protected from the heat during the integral molding. Thus, the connector portion 5 having the connector housing portion 56 is formed at the other longitudinal end of the body 1 remote from the injection orifice 24. For example, the fuel inlet port 11 has an outer end (right end in FIG. 1) in the first radially outward direction of the body 1, and the fuel outlet port 15 has an outer end (left end in FIG. 1) in the second radially outward direction of the body 1. In the above state, the connector portion 5 is provided between the outer end of the fuel inlet port 11 and the outer end of the fuel outlet port 15 as shown in FIG. 1.

In a comparison case, where a pressure sensor is provided to a fuel injection apparatus that does not originally have the pressure sensor, the physical size of the entire fuel injection apparatus may become very large depending on the arrangement of the pressure sensor to the fuel injection apparatus. However, in the present embodiment, because the pressure sensor 50 (physical quantity measurement unit) for measuring pressure of high pressure fuel introduced through the fuel inlet port 11 is provided between the fuel inlet port 11 and the fuel outlet port 15, it is possible to limit the physical size of the fuel injection apparatus from increasing while the physical quantity measurement unit is successfully provided to the fuel injection apparatus.

Also, the fuel injection apparatus has the connector housing portion 56 that receives therein both of (a) the first terminals 55a connected to the pressure sensor 50 and (b) the second terminals 55b connected to the pressure control unit 3, 4. As a result, an additional connector for connecting with the pressure sensor 50 is not required for the fuel injection apparatus, and thereby it is possible to limit the size of the fuel injection apparatus from increasing. At the same time, it is possible to improve the operability of assembly of the fuel injection apparatus to the vehicle. It should be noted that, specifically, the second terminals 55b are connected to the two lead wires 411 of the piezo actuator 41 that constitutes the pressure control unit.

Also, the mount hole 13 is formed at the other longitudinal end of the body 1 to be fixed with the pressure sensor 50, and the body 1 has the high pressure fuel branch passage 14 that branches from the high-pressure fuel passage 12 toward the mount hole 13. The pressure sensor 50 is configured to measure a physical quantity of high pressure fuel that flows into or is introduced to the mount hole 13 through the high pressure fuel branch passage 14.

Also, the threaded member 51 of the pressure sensor 50 defines the bore 51a therein to have a hollow tubular shape, and the threaded member 51 is threadably engaged with the mount hole 13 of the body 1 such that high pressure fuel is capable of reaching the pressure measuring element 52a through the bore 51a of the threaded member 51. Thus, it is possible to easily attach the pressure sensor 50 to the body 1.

It should be noted that the present invention is not limited to the above embodiment, and the present invention may be modified into various embodiments based on the gist of the present invention.

For example, the above embodiment employs a pressure sensor that serves as a physical quantity measurement unit for measuring pressure of high pressure fuel as the physical quantity of high pressure fuel. However, the physical quantity measurement unit is not limited to the above pressure sensor. For example, the physical quantity measurement unit may be alternatively a temperature sensor that measures temperature of high pressure fuel.

Also, the above embodiment employs the fuel injection apparatus, in which the piezo actuator 41 serves as an actuator for opening and closing the nozzle 2. However, for example, the present invention may be alternatively applied to a solenoid fuel injection apparatus, in which a solenoid valve (solenoid valve) serves as the actuator for opening and closing the nozzle 2.

Also, in the above embodiment, the pressure sensor 50 is threadably engaged with the body 1. However, the pressure sensor 50 may be alternatively fixed to the body 1 by a method other than the threadable engagement as above. For example, adhesive or welding may be employed alternatively.

Also, in the above embodiment, the high pressure fuel branch passage 14 is formed such that high pressure fuel flows into the mount hole 13 that is formed at the other longitudinal end of the body 1 remote from the injection orifice 24. Also, the pressure sensor 50 is attached to the mount hole 13. However, high pressure fuel is not necessarily caused to flow into the mount hole 13 that is to be attached with the pressure sensor 50. For example, high pressure fuel may alternatively reach the pressure sensor 50 through a route different from the route that passes through a specific part of the body 1, which part is fixed to the pressure sensor 50.

Also, in the embodiment, the body 1 has the high pressure fuel branch passage 14 that branches from the high-pressure fuel passage 12 to extend toward the mount hole 13. However, for example, a fuel passage may be alternatively formed such that the fuel passage extends from the fuel inlet port 11 directly toward the mount hole 13.

Additional advantages and modifications will readily occur to those skilled in the art. The invention in its broader terms is therefore not limited to the specific details, representative apparatus, and illustrative examples shown and described.

What is claimed is:

1. A fuel injection apparatus comprising:
a body having:
a fuel inlet port, through which high pressure fuel is introduced; and
a high-pressure fuel passage that is communicated with the fuel inlet port;
a nozzle having an injection orifice that allows high pressure fuel to be injected therethrough when the nozzle is opened, high pressure fuel being introduced to the nozzle from the fuel inlet port through the high-pressure fuel passage; and
a pressure control unit that controls opening and closing of the nozzle by controlling pressure applied to a nozzle needle of the nozzle in accordance with an electric signal received from an exterior, wherein:
the fuel inlet port projects in a radially outward direction of the body; and
the body includes a fuel outlet port located on a lateral side of a longitudinal axis of the body opposite from the fuel inlet port, the fuel outlet port allowing excessive fuel within the fuel injection apparatus to be drained, the fuel injection apparatus further comprising:
a physical quantity measurement unit that is provided between the fuel inlet port and the fuel outlet port, the physical quantity measurement unit measuring a physical quantity of high pressure fuel introduced from the fuel inlet port.

2. The fuel injection apparatus according to claim 1, further comprising a connector housing portion that receives therein both of:
a first terminal connected to the physical quantity measurement unit; and
a second terminal connected to the pressure control unit.

3. The fuel injection apparatus according to claim 1, wherein:
the nozzle is disposed on a first longitudinal end of the body;
the body has a mount hole that is disposed on a second longitudinal end of the body opposite from the first longitudinal end, the mount hole being fixed to the physical quantity measurement unit;
the body has a high pressure fuel branch passage that branches from the high-pressure fuel passage to extend toward the mount hole; and
the physical quantity measurement unit measures the physical quantity of high pressure fuel that flows into the mount hole through the high pressure fuel branch passage.

4. The fuel injection apparatus according to claim 3, wherein:
the physical quantity measurement unit has a hollow tubular shape;
the physical quantity measurement unit has:
a threaded member formed with an external threaded part at an outer peripheral surface of the threaded member, the threaded member having a bore therein; and
a physical quantity measuring element that is attached to one end of the threaded member;
the mount hole is a threaded hole that is threadably engageable with the threaded member; and
the threaded member is threadably engaged with the mount hole such that high pressure fuel flows from the fuel inlet port to reach the physical quantity measuring element through the mount hole and the bore of the threaded member.

5. The fuel injection apparatus according to claim 1, wherein the connector housing portion is made of a resin integrally with the physical quantity measurement unit.

6. The fuel injection apparatus according to claim 1, wherein:
the radially outward direction, in which the fuel inlet port projects, is a first radially outward direction;
the fuel outlet port projects in a second radially outward direction of the body 1; and
the first radially outward direction is different from the second radially outward direction.

7. The fuel injection apparatus according to claim 1, wherein:
the radially outward direction, in which the fuel inlet port projects, is a first radially outward direction;
the fuel inlet port has an outer end in the first radially outward direction; and
the fuel outlet port has an outer end in a second radially outward direction of the body, which direction is different from the first radially outward direction, the fuel injection apparatus further comprising:
a connector portion that has the connector housing portion, wherein the connector portion is provided between the outer end of the fuel inlet port and the outer end of the fuel outlet port.

8. The fuel injection apparatus according to claim 1, wherein:
the physical quantity measurement unit is a pressure sensor; and
the physical quantity measuring element is a pressure detecting element.
